(19) United States
(12) Patent Application Publication
(10) Pub. No.: US 2021/0253196 A1
(43) Pub. Date: Aug. 19, 2021

(54) CONTROL DEVICE, CONTROL METHOD, PROGRAM, AND MOVING OBJECT

(71) Applicant: SONY CORPORATION, TOKYO (JP)

(72) Inventor: KAZUTO YOKOYAMA, KANAGAWA (JP)

(21) Appl. No.: 17/049,401

(22) PCT Filed: Apr. 22, 2019
(86) PCT No.: PCT/JP2019/016950

§ 371 Date: Oct. 21, 2020

(30) Foreign Application Priority Data
May 7, 2018 (JP) 2018-089190

(51) Int. Cl. B62M 6/50; B60L 50/20; B60L 15/20

(52) U.S. Cl. CPC B62M 6/50; B60L 15/20; B60L 50/20

(57) ABSTRACT

A control device according to an embodiment of the present technology includes: an acquisition unit; a detection unit; and a control unit. The acquisition unit acquires external force information regarding an external force to be applied to a moving object including a drive source. The detection unit detects a human force and a resistance force on the basis of the acquired external force information, the human force causing the moving object to move, the resistance force being imposed on the moving object. The control unit calculates a first control value corresponding to the detected human force, and a second control value corresponding to the detected resistance force, and controls the drive source on the basis of the first and second control values.

### TECHNICAL FIELD

The present technology relates to a control device applicable to drive control of a moving object that is movable by a human force, a control method, a program, and a moving object.

### BACKGROUND ART

In the past, a moving object that is movable by a human force and a drive force has been developed. For example, Patent Literature 1 describes a human force vehicle (skating board) including a motor. This human force vehicle moves with an impulse-type human force provided by user's foot as a propulsion force. In the human force vehicle, the drive torque of the motor is controlled to follow the reference velocity generated by a control unit. The control of the driving torque is started when it is estimated that a human force has not been applied, and is stopped when it is estimated that a human force has been applied. This enables the human force vehicle to run without damping the propulsion force caused by the human force (pages 2 to 6, FIGS. 1 and 2, etc. of Patent Literature 1).

### CITATION LIST

### Patent Literature

Patent Literature 1: WO 2016/079614

### DISCLOSURE OF INVENTION

### Technical Problem

In such moving object using the propulsion force by a human force, it is important to control the drive force of a motor or the like, and there is a need for a technology of improving usability of a moving object that is movable by a human force.

In view of the circumstances as described above, it is an object of the present invention to provide a control device capable of improving usability of a moving object that is movable by a human force, a control method, a program, and a moving object.

### Solution to Problem

In order to achieve the above-mentioned object, a control device according to an embodiment of the present technology includes: an acquisition unit; a detection unit; and a control unit.

The acquisition unit acquires external force information regarding an external force to be applied to a moving object including a drive source.

The detection unit detects a human force and a resistance force on the basis of the acquired external force information, the human force causing the moving object to move, the resistance force being imposed on the moving object.

The control unit calculates a first control value corresponding to the detected human force, and a second control value corresponding to the detected resistance force, and controls the drive source on the basis of the first and second control values.

In this control device, from external force information regarding an external force to be imposed on a moving object including a drive source, a human force to move the moving object and a resistance force to be imposed on the moving object are detected. A first control value corresponding to the human force and a second control value corresponding to the resistance force are calculated from the detection result, and the drive source of the moving object is controlled on the basis of the respective control values. In this manner, by controlling the drive source in accordance with each of the human force and the resistance force, it is possible to improve usability of the moving object that is movable by a human force.

The control unit may combine the first control value and the second control value to calculate a combined control value, and may control the drive source on the basis of to the calculated combined control value.

Thus, for example, it is possible to calculate an appropriate control value corresponding to the human force and the resistance force. As a result, the drive source can be stabilized and usability of the moving object can be improved.

The second control value may be a control value for canceling a resistance force to be imposed on the moving object.

This makes it possible to, for example, sufficiently reduce the resistance force, and to provide a comfortable driving experience. As a result, it is possible to exhibit excellent usability.

The control unit may calculate a second control value for realizing a virtual moving resistance by reducing the detected resistance force.

This makes it possible to, for example, provide a driving experience with a virtual moving resistance, and greatly improve usability of the moving object.

The first control value may be a control value for amplifying a human force that moves the moving object.

This allows a user to easily move the moving object and provide a comfortable driving experience. As a result, it is possible to exhibit excellent usability.

The control unit may remove a deceleration component that decelerates the moving object from the detected human force, and may calculate the first control value from the human force from which the deceleration component has been removed.

As a result, it is possible to accurately amplify the human force applied to the moving object. As a result, for example, it is possible to realize moving at the velocity corresponding to the operation of a user with high accuracy.

The detection unit may be capable of detecting, on the basis of the external force information, the external force applied to the moving object.

As a result, it is possible to easily detect a human force and a resistance force contained in the external force.

The detection unit may detect the human force by subtracting the resistance force from the detected external force.

As a result, it is possible to easily detect a human force, and properly control the drive source or the like even when, for example, there is no sensor or the like for detecting a human force.

The external force information may include an output from a human force sensor mounted on the moving object. In this case, the detection unit may detect the human force on the basis of the output of the human force sensor, and detect the resistance force by subtracting the human force from the detected external force.

As a result, it is possible to easily detect a resistance force. As a result, for example, it is possible to shorten the detecting process for detecting a resistance force.

The moving object may be a kick vehicle. In this case, the detection unit may detect, as the human force, a force that kicks a road surface on which the vehicle travels.

This makes it possible to easily cause a kick vehicle capable of moving by a human force to travel, and realize a kick vehicle that exhibits excellent usability.

The moving object may include a drive mechanism that converts the human force into a propulsion force of the moving object. In this case, the detection unit may detect the propulsion force as the human force.

As a result, it is possible to detect the propulsion force by a human force with high accuracy. As a result, for example, it is possible to execute the control of drive source corresponding to the operation of a user with sufficiently high accuracy.

The moving object may include a wheel that is in contact with a road surface. In this case, the detection unit may detect, as the resistance force, at least one of a rolling resistance of the wheel, a gradient resistance of the road surface, and an air resistance.

As a result, it is possible to detect a resistance force to be imposed on the moving object in detail, and realize, for example, control of a drive source according to the moving environments of the moving object.

The moving object may include a sensor unit including at least one of an acceleration sensor, a velocity sensor, an image sensor, and a wind velocity sensor. In this case, the acquisition unit may acquire an output of the sensor unit as the external force information.

As a result, it is possible to accurately detect an external force to be applied to the moving object. As a result, the control accuracy of the drive source is improved, and usability of the moving object can be sufficiently improved.

The detection unit may detect a velocity of the moving object on the basis of the output of the image sensor.

For example, by using an image sensor, it is possible to accurately detect the velocity of the moving object. As a result, it is possible to improve the accuracy of detecting the external force or the like applied to the moving object.

The moving object may include a wheel that is in contact with a road surface. In this case, the detection unit may detect a rolling resistance coefficient of the wheel with respect to the road surface on the basis of the output of the image sensor.

For example, by using an image sensor, it is possible to detect the rolling resistance of the wheel according to the condition of the road surface or the like, and accurately detect the resistance force to be imposed on the moving object.

The detection unit may detect a gradient of a road surface on the basis of an output of the image sensor.

As a result, it is possible to easily detect the gradient of the road surface, and easily detect the gradient resistance of the road surface, and the like.

A control method according to an embodiment of the present technology is a control method executed by a computer system, including acquiring external force information regarding an external force to be applied to a moving object including a drive source.

A human force and a resistance force are detected on the basis of the acquired external force information, the human force causing the moving object to move, the resistance force being imposed on the moving object.

A first control value corresponding to the detected human force, and a second control value corresponding to the detected resistance force are calculated, and the drive source is controlled on the basis of the first and second control values.

A program according to an embodiment of the present technology causes a computer system to execute the following steps:

acquiring external force information regarding an external force to be applied to a moving object including a drive source;

detecting a human force and a resistance force on the basis of the acquired external force information, the human force causing the moving object to move, the resistance force being imposed on the moving object; and

calculating a first control value corresponding to the detected human force, and a second control value corresponding to the detected resistance force, and controlling the drive source on the basis of the first and second control values.

A moving object according to an embodiment of the present technology includes: a drive source; an acquisition unit; a detection unit; and a control unit.

The drive source causes the moving object to move.

The acquisition unit acquires external force information regarding an external force to be applied to a moving object including a drive source.

The detection unit detects a human force and a resistance force on the basis of the acquired external force information, the human force causing the moving object to move, the resistance force being imposed on the moving object.

The control unit calculates a first control value corresponding to the detected human force, and a second control value corresponding to the detected resistance force, and controls the drive source on the basis of the first and second control values.

### Advantageous Effects of Invention

As described above, in accordance with the present technology, it is possible to improve usability of a moving object that is movable by a human force. Note that the effect described here is not necessarily limitative, and any of the effects described in the present disclosure may be provided.

### BRIEF DESCRIPTION OF DRAWINGS

FIG. 1 is a schematic diagram showing a configuration example of an electric kick skater according to an embodiment of the present technology.

FIG. 2 is a block diagram showing a configuration example of a controller.

FIG. 3 is a block diagram showing a configuration example of a power calculation unit.

FIG. 4 is a flowchart showing an example of control processing by the controller.

FIG. 5 is a graph showing an example of control processing of the kick skater.

FIG. 6 is a graph showing an example of the control processing of the kick skater.

FIG. 7 is a graph showing an example of the control processing of the kick skater.

FIG. 8 is a graph showing an example of the control processing of the kick skater.

FIG. 9 is a graph showing another example of the control processing of the kick skater.

FIG. 10 is a graph showing another example of the control processing of the kick skater.

FIG. 11 is a graph showing another example of the control processing of the kick skater.

FIG. 12 is a graph showing an example of traveling data of the kick skater.

### MODE(S) FOR CARRYING OUT THE INVENTION

An embodiment according to the present technology will now be described below with reference to the drawings.

[Configuration of Electric Kick Skater]

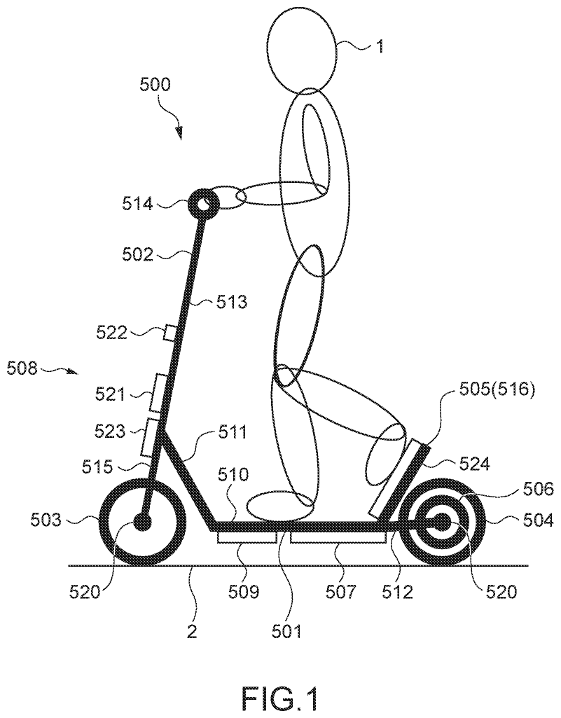

FIG. 1 is a schematic diagram showing a configuration example of a kick skater (hereinafter, referred to simply as the kick skater) according to an embodiment of the present technology. A kick skater 500 is a kick vehicle that travels by a user 1 kicking a road surface 2. Further, the kick skater 500 can also be driven by an electric drive force. The kick skater 500 is an example of the moving object according to the present technology.

The kick skater 500 includes a board portion 501, a handle portion 502, a front wheel 503, a rear wheel 504, a drive pedal 505, and a drive motor 506. Further, the kick skater 500 includes a battery 507, a sensor unit 508, and a controller 509. As shown in FIG. 1, the side on which the handle portion 502 is provided is the front side of the kick skater 500, and the side opposite thereto is the rear side.

The board portion 501 includes a board 510, a handle support portion 511, and a rear wheel support portion 512. The board 510 is a portion on which the user 1 places one or both feet, and has a substantially plate-like shape extending in the front-rear direction.

The handle support portion 511 is coupled to the front end of the board 510. An insert hole (not shown) into which a stem 513 of the handle portion 502 described below is inserted is provided on a side of the handle support portion 511 that is opposed to a side coupled to the board 510.

The rear wheel support portion 512 is coupled to the rear end of the board 510. The rear wheel support portion 512 includes, for example, two support members facing each other at a distance. The rear wheel 504 is rotatably supported so as to be sandwiched between these two support members.

The specific configuration of the board portion 501 is not limited. For example, a folding mechanism for folding the handle portion 502 (the stem 513) along the board 510, or the like may be provided. Further, a foot brake for stopping the rear wheel 504, a mud removing cover, and the like may be appropriately installed.

The handle portion 502 includes a stem 513, a handle 514, and a front wheel support portion 515. The stem 513 includes a frame extending in substantially the up-and-down direction. The stem 513 is rotatably supported by being inserted into the insertion hole of the handle support portion 511. The handle 514 extends in the right and left direction as viewed from the user 1 and is fixedly connected at its center to the upper end of the stem 513. In FIG. 1, the handle 514 seen from the left side is schematically illustrated.

The handle 514 includes a left grip to be held by the left hand and a right grip to be held by the right hand. For example, the right grip functions as an operating grip for controlling the output of the drive motor 506. The input value input by the operation grip is used for output control or the like by the controller 509 described below. Further, the right grip and the left grip are appropriately provided with brakes and the like for the front wheel and the rear wheel. In addition, the handle 514 is provided with a switch or the like for operating the controller 509.

The front wheel support portion 515 is provided at the lower end of the stem 513. The front wheel support portion 515 includes, for example, two support members facing each other at a distance. The front wheel 503 is rotatably supported so as to be sandwiched between these two support members. Therefore, the user 1 can manipulate the orientation of the front wheel 503 by manipulating the orientation of the handle 514, thereby controlling the traveling direction of the kick skater 500 and the like.

The front wheel 503 and the rear wheel 504 are wheels that are in contact with the road surface 2 on which the kick skater 500 travels. The wheels are configured, for example, by using a tire in contact with the road surface 2 and a wheel that supports the tire. Note that in the kick skater 500, the rear wheel 504 functions as a drive wheel.

Note that the configuration of the wheels of the kick skater 500 is not limited to the example shown in FIG. 1. For example, a three-wheel configuration in which the front side (rear side) of the kick skater 500 includes a pair of right and left wheels and the rear side (front side) includes a single wheel may be employed. Further, a four-wheel configuration including a pair of left and right wheels on both the front and rear sides may be employed. Thus, it is possible to realize stable traveling.

The drive pedal 505 is located behind the board 510. One end of the drive pedal 505 is connected to the board 510, and is configured to be pivotable about the connected position as a fulcrum. Further, a transmission mechanism using a chain, a gear, or the like (not shown) is connected to the drive pedal 505. The transmission mechanism is capable of converting the pivoting motion of the drive pedal 505 into rotational motion and transmit it to the rear wheel 504.

For example, as shown in FIG. 1, when the user 1 steps on the drive pedal 505, the force for depressing the drive pedal 505 (the operation force by the user 1) is transmitted to the rear wheel 504 through the transmission mechanism. In this way, the drive pedal 505 and the transmission mechanism function as a drive mechanism 516 that converts the operation force by the user 1 into the propulsion force of the kick skater 500. By providing the drive mechanism 516, for example, the user 1 can manipulate the kick skater 500 in a comfortable posture without bending the pivot foot (the foot opposite to the foot placed on the drive pedal 505). The specific configuration of the drive mechanism 516 is not limited.

The drive motor 506 generates a drive force that causes the wheel of the kick skater 500 to rotate. In the example shown in FIG. 1, the drive motor 506 is configured to cause the rear wheel 504 of the kick skater 500 to rotate. As a result, it is possible to drive the kick skater 500 using the drive force of the drive motor 506.

As the drive motor 506, for example, an in-wheel motor formed in the wheel of the rear wheel 504 is used. As a result, it is possible to form the kick skater 500 to be compact. Further, the drive motor 506 may be disposed outside the rear wheel 504. In this case, the drive force of the drive motor 506 is transmitted to the rear wheel 504 via a transmission mechanism using a chain, a gear, or the like.

The specific configuration of the drive motor 506, the transmission mechanisms, and the like is not limited. For example, the drive motor 506 may be configured to be capable of causing the front wheel 503 or both wheels to rotate. Alternatively, an arbitrary configuration in which the wheel (the rear wheel 504) of the kick skater 500 is caused to rotate by an electric drive force may be used. In this embodiment, the drive motor corresponds to the drive source.

As described above, the kick skater 500 is a powered kick vehicle. That is, the kick skater 500 is capable of moving by using both of the operation force by the user 1 (the force that the user 1 kicks the road surface 2 and the force that the user 1 steps on the drive pedal 505) and the drive force of the drive motor 506 as the drive force.

Note that the operation force by the user 1 is a human force generated by the operation of the user 1, and is a force acting on the kick skater 500 to cause the kick skater 500 to move. In the following, the operation force by the user 1 is described simply as human force in some cases.

Further, when the kick skater 500 moves, the kick skater 500 receives a traveling resistance in a direction opposed to the traveling direction. Here, the traveling resistance is, for example, the rolling resistance of the wheel, the gradient resistance of the road surface 2, and the air resistance, and is a force acting in a direction that prevents the kick skater 500 from moving. In this embodiment, the traveling resistance correspond to the resistance force.

In the present disclosure, the human force and the traveling resistance are included in the external force applied to the kick skater 500. For example, an external force including a human force and a traveling resistance is applied from the outside of the kick skater 500 to the moving kick skater 500, and the drive force of the drive motor 506 is applied from the inside of the kick skater 500. The combined force of the external force and the drive force causes the kick skater 500 to move. The external force and the drive force applied to the kick skater 500 will be described below in detail.

The battery 507 is attached to the board 510 and supplies electric power to the sensor unit 508, the drive motor 506, the controller 509, and the like. The battery 507 is configured to be attachable/detachable to/from the board 510, for example. The battery 507 is mounted when the kick skater 500 is used, and the battery 507 is removed when the kick skater 500 is charged or the like.

Note that the battery can be charged by connecting to a power cable or the like while the battery 507 is attached.

The specific configuration of the battery 507 is not limited. For example, the battery 507 may be attached to the stem 513. As a result, it is possible to perform, for example, a charging operation of the battery 507. Further, the battery 507 may be incorporated in the drive wheel (the front wheel 503 or the rear wheel 504). As a result, for example, it is possible to simplify the device configuration of the kick skater 500, and simplify the assembling process and the like. Alternatively, the battery 507 may be provided at an arbitrary position of the kick skater 500.

The sensor unit 508 includes a wheel velocity sensor 520, an acceleration sensor 521, a camera 522, a wind velocity sensor 523, and a human force sensor 524.

The wheel velocity sensor 520 is disposed in the front wheel 503 and the rear wheel 504, and outputs wheel velocity data (rotational velocity) of each wheel. As the wheel velocity sensor 520, for example, an electromagnetic rotation velocity sensor using a resolver, a hole device, or the like, an optical rotation velocity sensor using an LD (Laser Diode), an LED (Light Emitting Diode), or the like is used. Note that the wheel velocity sensor 520 may be provided on the drive motor 506, the drive mechanism 516, or the like. In this embodiment, the wheel velocity sensor 520 corresponds to the velocity sensor.

The acceleration sensor 521 is disposed in the stem 513 and outputs acceleration data relating to the kick skater 500. The acceleration sensor 521 is configured to be capable of outputting acceleration data in, for example, two-axis (XY) or three-axis (XYZ) directions orthogonal to each other. As the acceleration sensor 521, for example, an inertial measuring unit (IMU) or the like is used. Note that it is possible to detect the attitude or the like of the kick skater 500 on the basis of the output (acceleration data.) of the acceleration sensor 521. Thus, the acceleration sensor 521 functions also as an attitude sensor.

The specific configuration of the acceleration sensor 521 is not limited. For example, the acceleration sensor 521 may be disposed on the board 510. Thus, for example, it is possible to suppress the effect of the steering operation (handle operation by the user 1) when detecting the acceleration or the like. As a result, it is possible to detect the acceleration and the like of the kick skater 500 with high accuracy. In addition, the acceleration sensor 521 may be disposed at an arbitrary position capable of appropriately detecting the acceleration or the like of the kick skater 500.

The camera 522 is disposed in the stem 513 so as to face the front side of the kick skater 500. The camera 522 outputs image data of the front side of the kick skater 500. As the camera 522, for example, an RGB camera or the like provided with an image sensor such as a CCD and a CMOS is used. In addition, an image sensor or the like for detecting infrared light or polarized light may be appropriately used. In this embodiment, the camera 522 corresponds to the image sensor.

The specific configuration of the camera 522 is not limited. For example, the camera 522 may be disposed at a predetermined position on the board 510 so as to face the front side. As a result, for example, it is possible to capture an image or the like in which the influence of the steering operation is suppressed, and thus it is possible to improve the accuracy of the image data.

Further, the present invention is not limited to the case where the camera 522 is disposed so as to face the front side, and for example, the camera 522 may be disposed so as to face the lower side or the rear side of the kick skater 500. Alternatively, a plurality of cameras 522 for imaging the respective directions may be disposed. As a result, it is possible to accurately detect, on the basis of the image data, parameters (the condition of the road surface 2, the gradient of the road surface 2, the velocity, the acceleration, and the like) relating to the driving environment and the driving state.

The wind velocity sensor 523 is disposed in the stem 513 so as to face the front side of the kick skater 500. The wind velocity sensor 523 outputs wind velocity data on the kick skater 500. For example, the wind velocity data corresponding to the wind pressure or the like received from the traveling direction of the kick skater 500 is output. As the wind velocity sensor 523, an anemometer such as a hot wire anemometer, a vane anemometer, and an ultrasonic anemometer is used. Note that the specific configuration of the wind velocity sensor 523 is not limited. For example, the wind velocity sensor 523 may be disposed on the board 510. As a result, it is possible to detect highly accurate wind velocity data or the like in which the influence of the steering operation or the like is suppressed.

The human force sensor 524 outputs human force data regarding a human force applied by the user 1 to cause the kick skater 500 to move. In this embodiment, a torque sensor disposed on the drive pedal 505 is used as the human force sensor 524. The torque sensor (the human force sensor 524) outputs, for example, a torque value transmitted to the rear wheel 504 when the user 1 steps on the drive pedal 505. Alternatively, as the human force sensor 524, a pressure sensor or the like for outputting a pressure value when the user 1 steps on the drive pedal 505 may be used.

The data and the like detected by the sensors included in the sensor unit 508 are output to the controller 509. Note that the type and the like of the sensor mounted on the kick skater 500 is not limited. For example, a temperature sensor for detecting the temperature of the drive motor 506, a GPS sensor or the like for detecting the position and orientation of the kick skater 500 may be appropriately mounted.

The controller 509 is accommodated in, for example, a casing (controller box) having waterproofness and dustproofness, and is installed at a predetermined position of the board 510. Note that in the controller box, various circuits (illustration omitted) such as a power supply circuit and a drive circuit for operating the drive motor 506, the controller 509, or the like are provided.

The position at which the controller 509 is disposed, and the like are not limited. For example, the controller 509 (controller box and the like) may be attached to the stem 513. Alternatively, the controller 509 may be incorporated in a drive wheel (the front wheel 503, the rear wheel 504, or the like). Alternatively, the controller 509 may be provided at an arbitrary position of the kick skater 500.

The controller 509 executes drive control for causing the kick skater 500 to move. Specifically, the controller 509 generates a control signal to be output to the drive circuit connected to the drive motor 506. As a result, it is possible to control the electric power to be supplied to the drive motor 506, and control the generation of the drive force by the drive motor 506.

The controller 509 corresponds to the control device according to this embodiment and includes hardware required for a computer, such as a CPU, a RAM, and a ROM. The CPU loads the program according to the present technology previously recorded in the ROM into the RAM and executes it, thereby executing the control method according to the present technology.

The specific configuration of the controller 509 is not limited. For example, a programmable logic device (PLD) such as a field-programmable gate array (FPGA), or another device such as an application-specific integrated circuit (ASIC) may be used.

[Configuration of Controller]

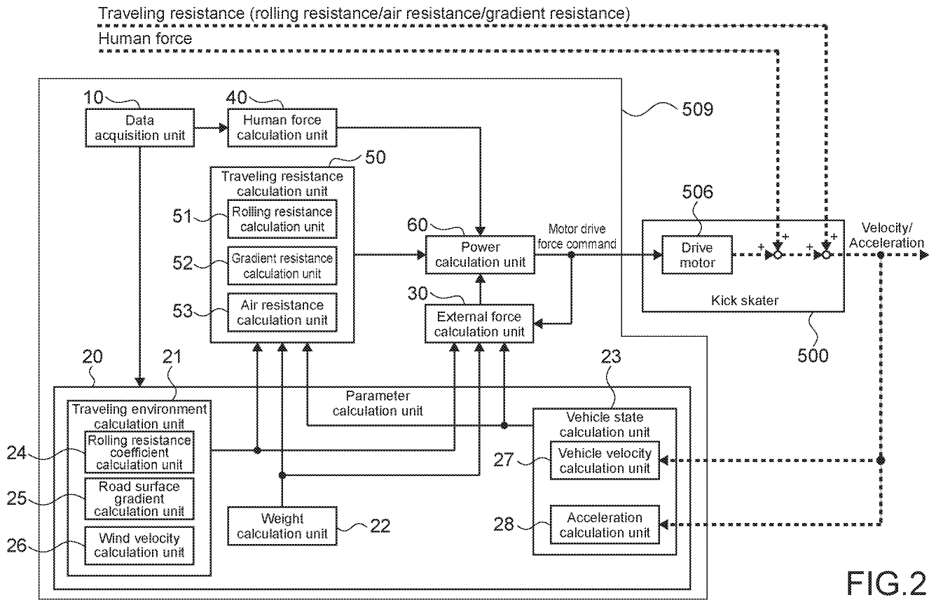

FIG. 2 is a diagram showing a configuration example of the controller 509. In FIG. 2, the data handled by the controller 509 or the like is schematically illustrated using solid arrows. Further, the physical amounts such as the traveling resistance and the human force applied to the kick skater 500 are schematically illustrated using dotted arrows.

The controller 509 includes a data acquisition unit 10, a parameter calculation unit 20, an external force calculation unit 30, a human force calculation unit 40, a traveling resistance calculation unit 50, and a power calculation unit 60.

The data acquisition unit 10 acquires the output of the sensor unit 508. That is, the data acquisition unit 10 acquires data output from the sensors included in the sensor unit 508. For example, the data acquisition unit 10 appropriately reads wheel velocity data, acceleration data, image data, wind velocity data, and human force data output from the wheel velocity sensor 520, the acceleration sensor 521, the camera 522, the wind velocity sensor 523, and the human force sensor 524, respectively.

As will be described below, the controller 509 detects, by using these pieces of data, the external force (a human force and a traveling resistance) applied to the kick skater 500. Therefore, it can also be said that the wheel velocity data, acceleration data, image data, wind velocity data, and human force data are external force information regarding the external force applied to the kick skater 500. In this manner, the data acquisition unit 10 acquires the external force information regarding the external force. In this embodiment, the data acquisition unit 10 corresponds to the acquisition unit.

Of the pieces of external force information, wheel velocity data, acceleration data, image data, and wind velocity data are output to the parameter calculation unit 20. Further, the human force data is output to the human force calculation unit 40. Note that the method or the like of acquiring data from each sensor is not limited, the output of the sensor required by each functional block may be directly read.

The parameter calculation unit 20 performs arithmetic processing of various parameters for detecting the external force applied to the kick skater 500 and the traveling resistance imposed on the kick skater 500. As shown in FIG. 2, the parameter calculation unit 20 includes a traveling environment calculation unit 21, a weight calculation unit 22, and a vehicle state calculation unit 23.

The traveling environment calculation unit 21 detects a parameter relating to the driving environment of the kick skater 500. The traveling environment calculation unit 21 includes a rolling resistance coefficient calculation unit 24, a road surface gradient calculation unit 25, and a wind velocity calculation unit 26.

The rolling resistance coefficient calculation unit 24 detects a rolling resistance coefficient of the wheel (the front wheel 503 and the rear wheel 504) relative to the road surface 2 on which the kick skater 500 travels. The rolling resistance is a resistance force that occurs in a direction opposite to the traveling direction when a cylindrical object such as a wheel rolls. The rolling resistance coefficient is a coefficient for calculating this rolling resistance, and is a value corresponding to the material and shape of the wheel(tire), the type and condition of the road surface, and the like.

In this embodiment, the rolling resistance coefficient calculation unit 24 detects, on the basis of the output of the camera 522, the rolling resistance coefficient of the wheel relative to the road surface 2. For example, analysis processing such as pattern matching is performed on the image data of the front side of the kick skater 500 obtained by imaging by the camera 522, and the type of the road surface 2 (asphalt, concrete, sand, etc.) and the condition of the road surface 2 (dry condition, wet condition, etc.) are detected. The rolling resistance coefficient according to the type and condition of the road surface 2 is calculated.

The method of detecting the rolling resistance coefficient from the image data is not limited, and an arbitrary analysis method capable of detecting the type, condition, and the like of the road surface 2 may be used, for example. Further, for example, processing of detecting a resistance coefficient using machine learning or the like may be executed. Further, as the rolling resistance coefficient, a coefficient stored in advance may be used.

The road surface gradient calculation unit 25 detects the slope (gradient) of the road surface 2 on which the kick skater 500 travels. In this embodiment, the road surface gradient calculation unit 25 detects the gradient of the road surface 2 on the basis of the output of the camera 522. For example, the magnitude of the gradient of the road surface is detected by analyzing processing such as pattern matching, machine learning, or the like from the image data of the front side of the kick skater 500 obtained by imaging by the camera 522.

The method of detecting the gradient of the road surface 2 is not limited. For example, the gradient of the road surface 2 may be detected by calculating the attitude of the kick skater 500 on the basis of the output of the acceleration sensor 521 (IMU). In addition, an arbitrary method capable of detecting a road surface gradient may be used.

The wind velocity calculation unit 26 detects the wind velocity of the wind or the like received by the kick skater 500 (the user 1). In this embodiment, the wind velocity is detected on the basis of the output of the wind velocity sensor. For example, the headwind, tailwind, and crosswind are detected, and the velocity of each of these winds is detected.

The weight calculation unit 22 calculates the total weight of the weight of the kick skater 500 and the weight of the user 1. For example, a fixed value (the default total weight) specifying the total weight, or the like is read. Alternatively, the sum of the body weight set by the user 1 (the weight of the user 1) and the weight of the kick skater 500 is calculated as the total weight. Further, for example, processing of estimating the total weight from the operation of the kick skater 500, or the like may be executed by using an estimation algorithm such as a Kalman filter.

The vehicle state calculation unit 23 detects the velocity and acceleration as parameters relating to the traveling state of the kick skater 500. The vehicle state calculation unit 23 includes a vehicle velocity calculation unit 27 and an acceleration calculation unit 28.

The vehicle velocity calculation unit 27 detects the velocity of the kick skater 500 (vehicle velocity). In this embodiment, the velocity of the kick skater 500 is detected on the basis of the output of the camera 522. For example, processing of estimating the velocity from the motion of the image data (camera image) obtained by imaging by the camera 522 is executed. The method of detecting the velocity of the kick skater 500 from the image data is not limited, and for example, an arbitrary analysis method capable of detecting the moving velocity or the like using the image data may be used. Further, for example, velocity detection using machine learning or the like may be executed.

Further, the velocity of the kick skater 500 may be detected on the basis of the wheel velocity data output from the wheel velocity sensor 520. The vehicle velocity calculation unit 27 detects the velocity of the kick skater 500 from the wheel velocity data (the rotational velocity data) using the diameter of each wheel, the length of the outer periphery, and the like stored in the ROM or the like. The method of detecting the velocity of the kick skater 500 is not limited.

The acceleration calculation unit 28 detects the acceleration of the kick skater 500. In this embodiment, the acceleration of the kick skater 500 is detected on the basis of the output of the acceleration sensor 521 (IMU). Further, for example, when the kick skater 500 travels straight, the acceleration in the same direction as the velocity is detected. Further, when the curve operation or the like is performed, the acceleration corresponding to the centrifugal force, or the like is detected.

The method of detecting the acceleration of the kick skater 500 is not limited, and acceleration detection using image data may be performed, for example. Further, for example, the acceleration may be detected by differentiating the velocity or the like detected by the vehicle velocity calculation unit 27. Alternatively, an arbitrary method capable of detecting the acceleration may be used.

The parameters (the vehicle velocity, acceleration, total weight, rolling resistance coefficient, road surface gradient, wind velocity, and the like) calculated by the parameter calculation unit 20 are output to the external force calculation unit 30 and the traveling resistance calculation unit 50. The functional blocks (the traveling environment calculation unit 21, the weight calculation unit 22, and the vehicle state calculation unit 23) of the parameter calculation unit 20 function as a part of the detection unit in this embodiment.

The external force calculation unit 30 detects an external force applied to the kick skater 500. Specifically, an external force is detected by using the parameters (the velocity, the acceleration, and the like) detected by the parameter calculation unit 20 on the basis of the external force information. Thus, in the controller 509, an external force applied to the kick skater 500 is detected on the basis of the external force information.

In the external force calculation unit 30, the magnitude and direction of the force (external force) that is the sum of various forces (a human force and a traveling resistance) acting on the kick skater 500 from the outside are detected. In other words, in addition to the drive force of the drive motor 506, the total amount and the direction (combined direction) of the forces applied to the kick skater 500 are detected.

As a method of detecting the external force, for example, a disturbance observer is used. The disturbance observer is a method of estimating the disturbance using a control result of a control target in a disturbance environment, for example, in a certain control system. In this embodiment, the controller 509 is a control system, and the kick skater 500 on which the user 1 rides is a control target. In the disturbance observer, for example, an external force is detected as a disturbance by using an output value (motor drive force command) of the power calculation unit 60 described later, a velocity of the kick skater 500, or the like.

In addition, the method of detecting the external force is not limited, and an arbitrary method capable of detecting the external force may be used. Hereinafter, the external force detected by the external force calculation unit 30 will be referred to as the external force detection value in some cases. The external force detection value is output to the power calculation unit 60.

The human force calculation unit 40 detects a human force that causes the kick skater 500 to move. In the human force calculation unit 40, a human force relating to the movement of the kick skater 500 is detected. In another aspect, it can be also said that the force applied by the user 1 to the kick skater 500 to cause the kick skater 500 to move is detected as a human force.

In this embodiment, a human force is detected on the basis of, the output of the human force sensor 524 provided in the drive pedal 505 shown in FIG. 1. As described above, the force that the user 1 steps on the drive pedal 505 is transmitted to the rear wheel 504 by the drive mechanism 516 and converted into a propulsion force. The human force calculation unit 40 detects the propulsion force converted by the drive mechanism 516, as a human force.

For example, the propulsion force is detected by executing conversion processing corresponding to the configuration of the drive mechanism 516 on the output (human force data) of the human force sensor 524. For example, in the case where the human force sensor 524 is a torque sensor, the propulsion force is calculated from the torque value output from the torque sensor. Further, in the case where the human force sensor 524 is a pressure sensor, the propulsion force is calculated from the pressure value output from the pressure sensor.

The method of detecting the propulsion force is not limited, and an arbitrary method capable of detecting the propulsion force may be used depending on the type of the human force sensor 524 and the configuration of the drive mechanism 516. The human force (propulsion force) detected by the human force calculation unit 40 is referred to as the human force detection value in some cases. The human force detection value is output to the power calculation unit 60.

The traveling resistance calculation unit 50 detects the traveling resistance imposed on the kick skater 500. The traveling resistance calculation unit 50 includes a rolling resistance calculation unit 51, a gradient resistance calculation unit 52, and an air resistance calculation unit 53.

The rolling resistance calculation unit 51 detects the rolling resistance imposed on the kick skater 500. The rolling resistance is proportional to the force applied from the wheel to the road surface. This proportional coefficient is the rolling resistance coefficient. Note that the force applied from the wheel to the road surface is calculated using, for example, the total weight (the total weight of the kick skater 500 and the user 1), the gravitational acceleration, and the gradient of the road surface 2.

The gradient resistance calculation unit 52 detects the gradient resistance imposed on the kick skater 500. The gradient resistance is a resistance force acting on, for example, when ascending the inclined road surface 2. The greater the gradient of the road surface 2, the greater the value of the gradient resistance. The gradient resistance is calculated using, for example, the total weight, the gravitational acceleration, and the gradient of the road surface 2.

The air resistance calculation unit 53 detects the air resistance imposed on the kick skater 500 and the user 1. The air resistance is a resistance imposed on the kick skater 500 and the user 1 when they move in the air. The air resistance is calculated on the basis of, for example, the wind velocity in the kick skater 500, the velocity of the kick skater 500, or the like.

Thus, in this embodiment, as the traveling resistance, the rolling resistance of the wheel, the gradient resistance of the road surface 2, and the air resistance are detected. The traveling resistance calculation unit 50 calculates the sum of the respective resistances, i.e., the sum of the rolling resistance, the gradient resistance, and the air resistance to detect the traveling resistance. Hereinafter, the traveling resistance detected by the traveling resistance calculation unit 50 will be referred to as the traveling resistance detection value in some cases. The traveling resistance detection value is output to the power calculation unit 60.

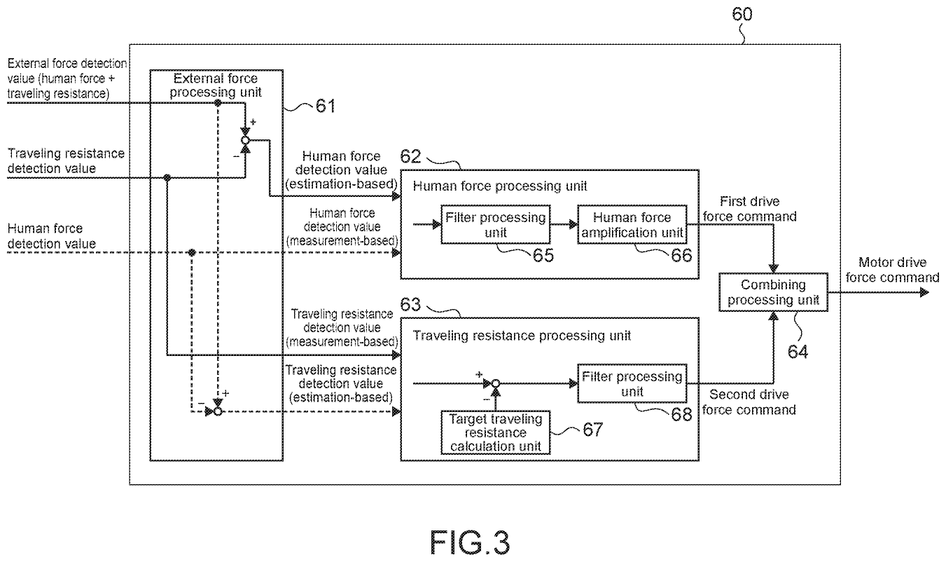

FIG. 3 is a block diagram showing a configuration example of the power calculation unit 60. The power calculation unit 60 includes an external force processing unit 61, a human force processing unit 62, a traveling resistance processing unit 63, and a combining processing unit 64.

The external force processing unit 61 is capable of detecting a human force and a traveling resistance from the external force detection value. In FIG. 3, the flow of data when a human force is detected from the external force detection value is schematically illustrated by solid arrows. Further, the flow of data when the traveling resistance is detected from the external force detection value is schematically illustrated by dotted arrows.

In the processing of detecting a human force from the external force detection value (solid arrows), a human force is detected by subtracting the traveling resistance detection value from the external force detection value. FIG. 5 schematically shows the difference processing between the external force detection value (the plus (+) arrow of the solid line) and the traveling resistance detection value (the (−) arrow of the solid line).

It can be also said that this processing is processing of estimating a human force by using the external force value and the traveling resistance value detected on the basis of the actually measured data (external force information). In this case, the estimation-based human force detection value detected by the estimation processing and the measurement-based traveling resistance detection value detected on the basis of the measurement value (velocity or the like) are output from the external force processing unit 61.

Thus, it is possible to easily detect the human force using the external force detection value and the traveling resistance detection value. As a result, for example, in the case where user 1 kicks the road surface 2 without using the drive pedal 505 to cause the kick skater 500 to travel, it is possible to detect, as a human force, the force that kicks the road surface 2 on which the kick skater 500 travels. In addition, even in the case where the human force sensor 524 fails or the human force sensor 524 is not mounted, it is possible to detect the human force.

In the processing of detecting the traveling resistance from the external force detection value (dotted arrows), the traveling resistance is detected by subtracting the human force detection value from the external force detection value. FIG. 5 schematically shows the difference processing between the external force detection value (the plus (+) arrow of the dotted line) and the human force detection value (the (−) arrow of the dotted line).

It can be also said that this processing is processing of estimating the traveling resistance by using the external force detection value and the human force detection value detected on the basis of the actually measured data (external force information). In this case, the estimation-based traveling resistance detection value detected by the estimation processing and the measurement-based human force detection value detected on the basis of the measurement value (human force data, or the like) are output from the external force processing unit 61.

As a result, for example, it is possible to easily detect the traveling resistance, and significantly reduce the processing load or the like due to the arithmetic processing of the traveling resistance. Further, as the human force detection value, a value with high accuracy that is actually measured can be used.

In the external force processing unit 61, for example, the processing of detecting the human force from the external force detection value and the processing of detecting the traveling resistance from the external force detection value are appropriately switched and executed. For example, the measurement-based human force and the estimation-based traveling resistance are output (dotted arrows) in the case where the output of the human force sensor 524 is read, and the measurement-based traveling resistance and the estimation-based human force are output (solid arrows) in other cases. For example, such processing may be executed. As a result, it is possible to properly detect the human force and the traveling resistance regardless of whether or not the drive pedal 505 is used.

Further, for example, both the processing of detecting the human force from the external force detection value and the processing of detecting the traveling resistance from the external force detection value may be performed. In this case, the human force detection value and the traveling resistance detection value that are finally output from the external force processing unit 61 are appropriately selected. For example, such processing may be executed.

As described above, in this embodiment, the human force that causes the kick skater 500 to move and the traveling resistance imposed on the kick skater 500 are calculated by the external force calculation unit 30, the human force calculation unit 40, the traveling resistance calculation unit 50, and the external force processing unit 61 of the power calculation unit 60. In this embodiment, the external force calculation unit 30, the human force calculation unit 40, the traveling resistance calculation unit 50, and the external force processing unit 61 function as the detection unit.

The human force processing unit 62 calculates a drive force command according to the human force detection value. Here, the drive force command is a control value (command value) for controlling the drive force such as the torque of the drive motor 506. Hereinafter, the drive force command calculated by the human force processing unit 62 is referred to as a first drive force command.

In this embodiment, the first drive force command corresponds to the first control value.

As shown in FIG. 3, the human force processing unit 62 includes a filter processing unit 65 and a human force amplification unit 66. The filter processing unit 65 executes filtering processing such as noise removal on the human force detection value (measurement base/estimation base) output from the external force processing unit 61. The human force amplification unit 66 amplifies the filtered human force detection value to calculate a first drive force command. The human force processing unit 62 (the filter processing unit 65 and the human force amplification unit 66) will be described below in detail.

The traveling resistance processing unit 63 calculates a drive force command corresponding to the traveling resistance detection value. Hereinafter, the drive force command calculated by the traveling resistance processing unit 63 is described as a second drive force command. In this embodiment, the second drive force command corresponds to the second control value.

As shown in FIG. 3, the traveling resistance processing unit 63 includes a target traveling resistance calculation unit 67 and a filter processing unit 68. The target traveling resistance calculation unit 67 calculates a target virtual traveling resistance (target traveling resistance). Further, in the traveling resistance processing unit 63, subtraction processing of subtracting the target traveling resistance from the traveling resistance detection value (measurement base/estimation base) is executed.

The filter processing unit 68 executes filtering processing such as noise removal with respect to the result of the difference processing (the traveling resistance detection value—the target traveling resistance) and calculates a second drive force command. Note that as will be described below, the drive force specified by the second drive force command is set to act in a direction opposite to the traveling resistance imposed on the kick skater 500. The traveling resistance processing unit 63 (the target traveling resistance calculation unit 67 and the filter processing unit 68) will be described below in detail.

The combining processing unit 64 calculates a motor drive force command by combining the first drive force command and the second drive force command. For example, by adding the drive forces (control values) specified by the first and second drive force commands, a motor drive force command is calculated.

The method of combining the drive force commands is not limited, and for example, the first and second drive force commands may be weighted and combined as appropriate. Alternatively, an arbitrary method of combining the drive force commands may be used. In this embodiment, the motor drive force command corresponds to the combined control value.

With reference to FIG. 2 again, the motor drive force command output from the power calculation unit 60 (the combining processing unit 64) is output to the drive motor 506 via the drive circuit or the like. Then, the drive motor 506 is controlled on the basis of the motor drive force command. In this manner, the power calculation unit 60 controls the drive motor 506 on the basis of the first and second drive force commands. In this embodiment, the power calculation unit 60 functions as the control unit.

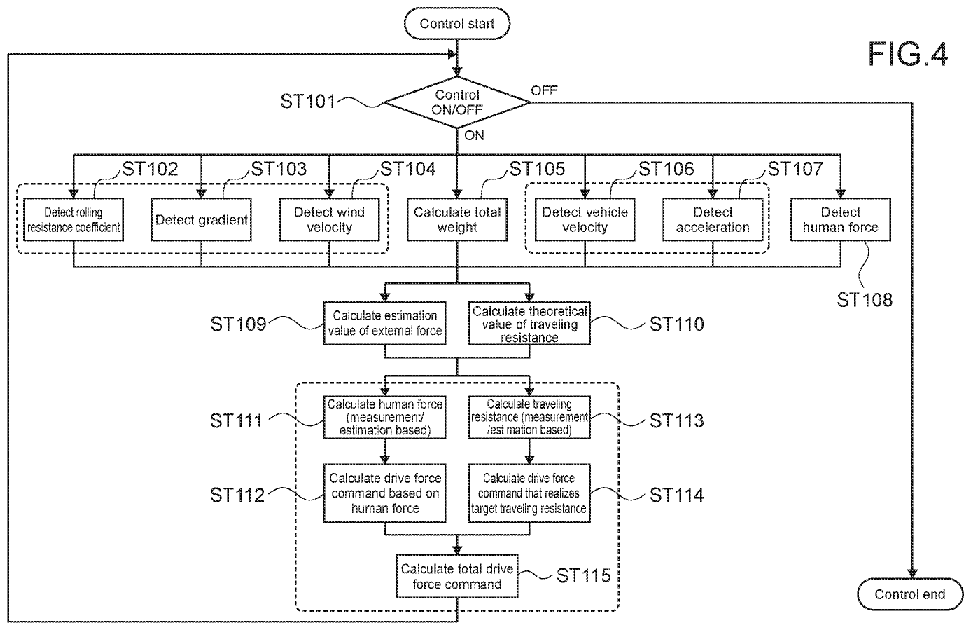

FIG. 4 is a flowchart showing an example of control processing by the controller 509. First, it is determined whether or not the control function of the drive motor 506 is valid (Step101). The validity (ON) and invalidation (OFF) of the control function are set by the user 1 via a switch or the like provided in the handle 514, for example.

In the case where it is determined that the control function is ON (ON in Step 101), the processing of Step102 to the processing of Step108 are executed in parallel.

In the traveling environment calculation unit 21, parameters relating to the driving environment in which the kick skater 500 travels are detected. Specifically, the rolling resistance coefficient calculation unit 24 calculates the rolling resistance coefficient of the wheel (Step102). Further, the road surface gradient calculation unit 25 detects the gradient of the road surface 2 (Step103). Further, the wind velocity calculation unit 26 detects the velocity of the wind received by the kick skater 500 (the user 1) (Step104).

In the weight calculation unit 22, the total weight obtained by summing the weight of the user 1 and the weight of the kick skater 500 is calculated (Step105). Note that in the case where it is determined that an appropriate total weight could have been calculated during the control processing, processing of storing the total weight and skipping Step105 may be executed.

In the vehicle state calculation unit 23, parameters relating to the traveling condition of the kick skater 500 is detected. Specifically, the vehicle velocity calculation unit 27 detects the velocity of the kick skater 500 (Step106). Further, the acceleration calculation unit 28 detects the acceleration of the kick skater 500 (Step107).

In the human force calculation unit 40, the propulsion force generated in the rear wheel 504 by operating the drive pedal 505 is detected on the basis of the human force data output from the human force sensor 524 (Step108). For example, in the case where the user 1 advances the kick skater 500 by stepping on the drive pedal 505, the propulsion force corresponding to the force applied by the user 1 is detected and output as a human force detection value.

Note that in the case where the user 1 is not operating the drive pedal 505, the propulsion force is zero. In this case, the output human force detection value is zero. Alternatively, a signal or the like for informing that the propulsion force (human force) is not detected may be output.

When the parallel processing from Step102 to Step108 is completed, the processing of detecting an external force (Step109) and the processing of detecting the traveling resistance (Step110) are executed in parallel.

In Step109, the external force calculation unit 30 detects an external force applied to the kick skater 500. As described with reference to FIG. 2, in the external force calculation unit 30, detection of an external force by, for example, a disturbance observer is executed.

In the method using the disturbance observer, for example, a vehicle dynamics model that has modeled the operation of the kick skater 500 on which the user 1 rides is established. In this case, the controller 509 can be regarded as a control system with a vehicle dynamics model as a controlled target. Further, the external force including a human force and a traveling resistance becomes an unknown external factor (disturbance) as seen from the control system.

For example, an output (velocity/acceleration, etc.) when there is no disturbances can be calculated from an input (motor drive command) to the vehicle dynamics model. Meanwhile, the output actually detected is a value affected by the disturbance. For example, the deviation between the output when there is no disturbance and the actual output is calculated on the basis of the vehicle dynamics model. As a result, it is possible to estimate a disturbance that is an external factor, i.e., an external force.

As described above, it can be also said that the external force (external force detection value) detected by the external force calculation unit 30 is an estimated value estimated on the basis of the vehicle dynamics model and the detection values of the velocity/acceleration, and the like. As a result, it is possible to properly detect the external force applied in accordance with the driving environment of the kick skater 500, the driving condition, the irregular operation of the user 1, or the like.

In Step110, the traveling resistance calculation unit 50 detects the traveling resistance imposed on the kick skater 500. Specifically, the rolling resistance, the gradient resistance, and the air resistance are respectively detected by the rolling resistance calculation unit 51, the gradient resistance calculation unit 52, and the air resistance calculation unit 53, and the traveling resistance detection value is calculated by summing these three kinds of resistances.

The rolling resistance, the gradient resistance, and the air resistance are theoretical values calculated on the basis of the dynamics model including the kick skater 500 and the user 1. In addition, as various parameters (the total weight, the gradient, the wind velocity, and the like) used in the dynamics model, various types of data (external force information) measured by the sensor unit are used. Therefore, it can be also said that the traveling resistance detection value is a measurement-based theoretical value.

Thus, it is possible to detect the traveling resistance imposed on the kick skater 500 with high accuracy in real time.

When Step109 and Step110 are completed, processing for calculating a motor drive force command is executed by the power calculation unit 60. In the power calculation unit 60, the processing of calculating the first drive force command according to a human force (Step111, Step112) and the processing of calculating the second drive force command according to the traveling resistance (Step113, Step114) are executed in parallel.

In Step111, the external force processing unit 61 outputs a human force detection value. For example, assumption is made that the user 1 has operated the drive pedal 505 (the dotted arrow in FIG. 3). In this case, the measurement-based human force detection value calculated by the human force calculation unit 40 in Step108 (the propulsion force of the human force) is output as it is. Further, for example, in the case where the user 1 is not operating the drive pedal 505, the estimation-based human force detection value estimated from the external force detection value is calculated (solid arrow in FIG. 3).

A first drive force command is calculated by the human force processing unit 62 on the basis of the human force detection value output from the external force processing unit (Step112). The first drive force command is a control value for generating a drive force that acts in the same direction as the human force that causes the kick skater 500 to move, i.e., in the traveling direction of the kick skater 500. Therefore, it can be also said that the first drive force command is a control value for amplifying the human force that causes the kick skater 500 to move. The magnitude of the drive force is set on the basis of the human force detection value.

As shown in FIG. 3, the human force detection value output from the external force processing unit 61 is input to the filter processing unit 65. In this embodiment, the filter processing unit 65 removes the deceleration components that decelerate the kick skater 500 from the human force detection value. Further, the human force amplification unit 66 calculates the first drive force command on the basis of the human force detection value from which the deceleration components have been removed.

For example, in the case where the user 1 kicks the road surface 2 to cause the kick skater 500 to travel, it is conceivable that a force that decelerate the kick skater 500 is generated at the moment when the foot of the user 1 is in contact with the road surface 2. In the filter processing unit 65, a deceleration component (a negative component or the like) acting in a direction opposite to the traveling direction is detected and removed from the human force detection value. The method of removing the deceleration component and the like are not limited.

By cutting the deceleration components in this manner, for example, it is possible to avoid a situation in which a drive force in the deceleration direction is generated or a situation in which the output of the drive motor 506 is instantaneously lowered. This makes it possible to suppress the generation of an unnatural decelerating feeling and the like, and improve the ride comfort of the kick skater 500. As a result, it is possible to exhibit excellent usability.

Further, in the filter processing unit 65, limiting processing for limiting the drive force, or the like is executed. For example, in the case where the human force detection value exceeds the predetermined upper limit, processing such as limiting the value output at a subsequent stage to a value substantially equal to the upper limit is executed. This enables the kick skater 500 to travel safely. Alternatively, the filter processing unit 65 may execute arbitrary filtering processing such as noise removal.

In the human force amplification unit 66, a first drive force command for amplifying the human force is calculated on the basis of the filtered human force detection value. For example, the control value for generating a drive force for amplifying the human force applied by the user 1 at a predetermined ratio of (0%, 10%, 20%, 30%, or the like) is calculated as the first drive force command. Note that the method of setting the ratio of amplifying the human force, and the like are not limited, and for example, an arbitrary ratio of 0% or more may be set as appropriate. Note that amplifying the human force by 0% is similar to not generating the drive force for assisting the human force.

In this manner, the human force processing unit 62 performs processing of appropriately amplifying the human force and reflecting it on the drive force of the drive motor 506. For example, it is possible to amplify the force of kicking the road surface 2 and the force of stepping on the drive pedal 505 by the user 1 at a predetermined rate, and sufficiently assist the operation by the user 1. As a result, the user 1 can easily achieve the target velocity, and it is possible to greatly improve usability of the kick skater 500.

The first drive force command has a value corresponding to the human force applied by the user 1. That is, the human force operation for moving is amplified as it is. As a result, the user 1 can experience, for example, the amplified acceleration in substantially real time, and it is possible to provide an excellent driving experience.

With reference to FIG. 4 again, in Step113, the external force processing unit 61 outputs a traveling resistance detection value. For example, in the case where the user 1 operates the drive pedal 505 (the dotted arrow in FIG. 3), the estimation-based traveling resistance detection value estimated from the external force detection value is calculated. Further, in the case where the user 1 is not operating the drive pedal 505 (the solid arrow in FIG. 3), the measurement-based traveling resistance value (theoretical value) calculated by the traveling resistance calculation unit 50 in Step110 is output as it is.

The traveling resistance processing unit 63 calculates the second drive force command on the basis of the traveling resistance detection value output from the external force processing unit 61 (Step114). The second drive force command is a control value for producing a drive force acting in a direction opposite to the traveling resistance. That is, the second drive force command is a control value for canceling the resistance force imposed on the kick skater 500. The magnitude of the drive force is set on the basis of the travelling resistance detection value and the target travelling resistance.

For example, assumption is made that the target traveling resistance is set to zero. In this case, as shown in FIG. 3, the travelling resistance detection value is input to the filter processing unit 68 as it is. As a result, the filter processing unit 68 calculates a second drive force command for generating a drive force having the same magnitude as the travelling resistance detection value and acting in a direction opposite to the traveling resistance. This drive force is a force that cancels substantially all of the traveling resistances imposed on the kick skater 500.

Thus, by canceling substantially all of the traveling resistance, it is possible to provide a driving experience as if traveling on the road surface 2 without traveling resistance. That is, it is possible to create a virtual road surface 2 in which the traveling resistance is zero, and the user 1 can experience a completely new sense of driving.

Further, for example, assumption is made that the target traveling resistance is set to a predetermined resistance value. In this case, from the filter processing unit 68, a second drive force command for generating a drive force acting in a direction opposite to the traveling resistance is calculated with the same magnitude as the value obtained by subtracting the predetermined resistance value from the traveling resistance detection value.

By applying this drive force, the traveling resistance imposed on the kick skater 500 can be adjusted to a predetermined resistance value. Thus, the traveling resistance processing unit 63 calculates a second drive force command for realizing a virtual traveling resistance by reducing the traveling resistance detection value. That is, it can be also said that the traveling resistance processing unit 63 performs processing of creating a feeling of the road surface 2 having a virtual traveling resistance.

For example, by setting the predetermined resistance value to a resistance value such as a traveling resistance when sliding on ice or a traveling resistance when running on concrete, it is possible to reproduce the driving experience in various scenes regardless of the type and the like of the actual road surface 2, and exhibit excellent entertainment.

Note that the target traveling resistance can be set to an arbitrary resistance value, and a virtual resistance value capable of reproducing various road surface such as wooden flooring, asphalt, grass, and sandy may be set. In addition, the method of setting the target traveling resistance is not limited, and for example, a ratio of canceling the traveling resistance (reduction ratio) or the like may be settable by the user 1.

With reference to FIG. 4 again, when the first drive force command and the second drive force command are calculated, the combining processing unit 64 calculates a motor drive force command (Step115). In the combining processing unit 64, a first drive force command and a second drive force command are combined. In other words, the total drive force command (motor drive force command) obtained by combining the drive force command based on the human force and the drive force command for realizing the target traveling resistance is calculated.

Thus, in the present disclosure, the first and second drive force commands are calculated by adjusting the human force and the traveling resistance in accordance with the values thereof, and combined to calculate a motor drive force command that is the final command value. That is, it can be also said that the torque command value to a motor is generated by focusing only on the dimension of the force (e.g., torque). Thus, a situation in which the drive force of the drive motor 506 changes discontinuously is avoided, and it is possible to realize stable traveling.

The calculated motor drive force command is output to the drive motor 506 (drive circuit). As a result, it is possible to control the drive force of the kick skater 500. When a motor drive force command is calculated, Step101 and subsequent Steps are looped and executed. Therefore, while the control function is ON, the above-mentioned processing is continuously executed. Further, in the case where the control switch or the like is stopped and it is determined that the control function is OFF (OFF in Step101), the looping processing ends.

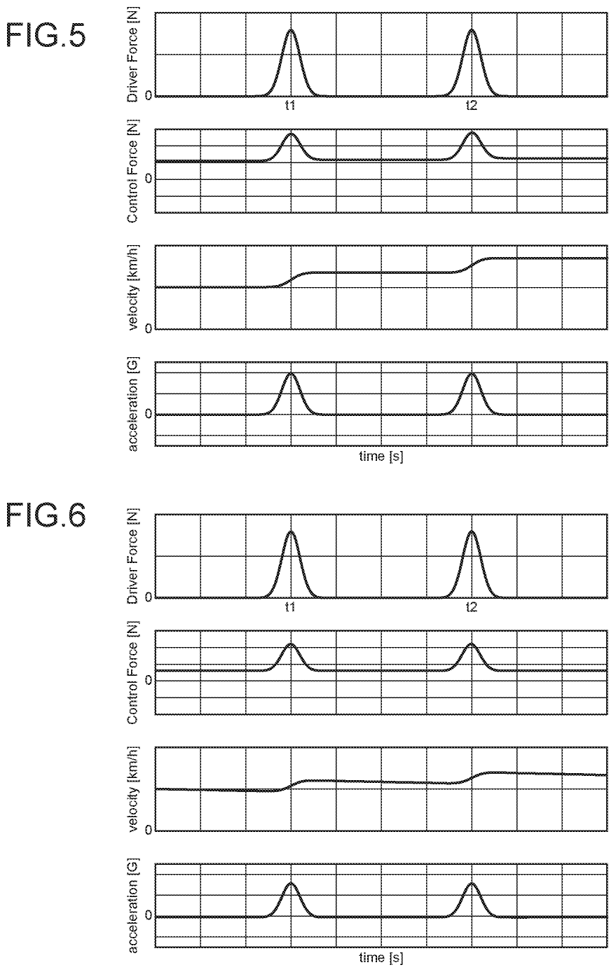

FIG. 5 to FIG. 8 are each a graph showing an example of control processing of the kick skater 500. FIG. 5 is a graph showing time changes of the human force (Driver Force), the drive force (Control Force) of the drive motor 506, the velocity, and the accelerations in order from the top. Further, the horizontal axis in each graph is a common time axis. Similarly, FIG. 6 to FIG. 8 show four types of graphs.

In FIG. 5 to FIG. 8, a drive force for amplifying the human force by 20% is generated. That is, a force of 1.2 times the human force applied by the user 1 acts on the kick skater 500. Needless to say, the traveling resistance, the drive force for cancelling the traveling resistance, and the like also act on the kick skater 500. Note that in FIG. 5 to FIG. 8, the human force (the uppermost graph) applied by the user 1 to the kick skater 500 is common.

For example, a human force having peak values at a time t1 and a time t2 is applied to the kick skater 500. Therefore, in FIG. 5 to FIG. 8, the first drive force command for generating the drive force for amplifying the human force by 20% is used. Hereinafter, the human force having a peak value at the time t1 (time t2) is referred to as the human force at the time t1 (time 2t).

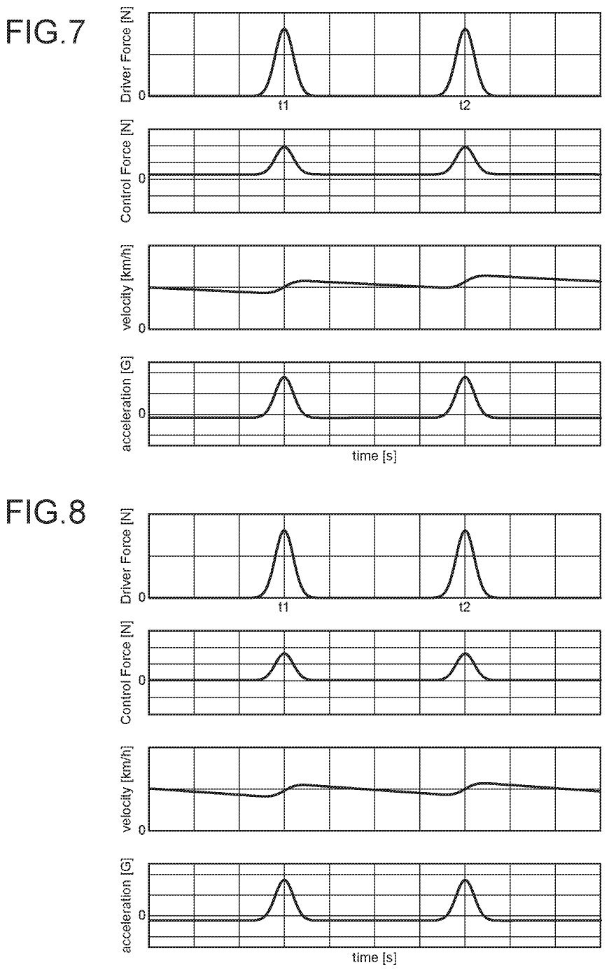

Further, in FIG. 5 to FIG. 8, the resistance value of the target traveling resistance, i.e., the ratio of canceling the traveling resistance differs. Specifically, in FIG. 5, FIG. 6, FIG. 7, and FIG. 8, graphs in the case of cancelling the traveling resistance by 100%, 70%, 30%, and 0% are shown respectively.

As shown in FIG. 5, in the case of canceling the traveling resistance by 100%, the target traveling resistance is set to zero. For example, before the human force at the time t1 is applied, the drive force acting in the traveling direction at the magnitude equal to the traveling resistance is supplied. This cancels the traveling resistance by 100%, and the kick skater 500 travels at a constant velocity. As a result, the user 1 can manipulate the kick skater 500 as if it were traveling on ice that receives no resistance force.

When the human force at the time t1 is applied, the drive force corresponding to the human force is combined with the drive force for cancelling the traveling resistance and supplied. As a result, the drive force exhibits a smooth peak structure in accordance with the application of the human force at the time t1. This drive force increases the velocity of the kick skater 500 smoothly. Further, the acceleration shows a smooth peak structure that continuously changes from the state of constant velocity motion (acceleration=0).

In this manner, by amplifying the detected human force as it is, the human force and the drive force can be naturally coordinated without canceling each other in this embodiment. As a result, it is possible to sufficiently avoid a situation in which unnatural acceleration, deceleration, or the like occurs. As a result, it is possible to provide a natural driving experience, and improve usability of the kick skater 500.

After the human force at the time t1 is applied, the kick skater 500 performs constant velocity motion at a velocity higher than that of the constant velocity motion before the time t1. In this case, for example, the traveling resistance such as the air resistance increases with an increase in velocity, and the drive force also increases. After that, when the human force at the time t2 is applied, the velocity of the kick skater 500 increases again. Thus, by setting the target traveling resistance to zero, it is possible to realize a driving experience such that the velocity is increased by the amount of the applied human force.

As shown in FIG. 6, in the case where the traveling resistance is canceled by 70%, the travelling with the resistance value reduced to 30% (virtual resistance) is realized. For example, the drive force when no human force is applied becomes smaller than that in FIG. 5, a gradual decrease in velocity due to the virtual resistance occurs. Even in such cases, by applying the human force at the time t1 or the time t2, the kick skater 500 is capable of increasing the velocity without causing an unnatural acceleration/deceleration or the like.

In FIG. 7, the traveling resistance is canceled by 30%, and the drive control leaving a 70% traveling resistance is executed. In this case, for example, as compared with FIG. 6, the reduction in the velocity when no human force is applied is remarkable. In addition, as shown in the graph of the acceleration, negative acceleration occurs with decreasing velocity. Note that the acceleration shown in FIG. 6 also has a negative value when no human force is applied. In this manner, by setting an arbitrary virtual resistance, it is possible to easily provide various driving experiences.

Further, as shown in FIG. 8, in the case of canceling the traveling resistance by 0%, i.e., in the case of not canceling the traveling resistance, the drive force when no human force is applied is zero. In this case, the user 1 can cause the kick skater 500 to travel while receiving the actual traveling resistance of the road surface 2 as it is.

Even in such a case, by increasing the human force applied by the user 1, it is possible to realize the acceleration larger than that by the actually applied force. As a result, it is possible to sufficiently assist the operation of the user 1. Further, since the drive force that cancels the traveling resistance is not generated, it is possible to suppress the power consumption of the kick skater 500, and improve the driving time of battery. For example, such control may be executed.

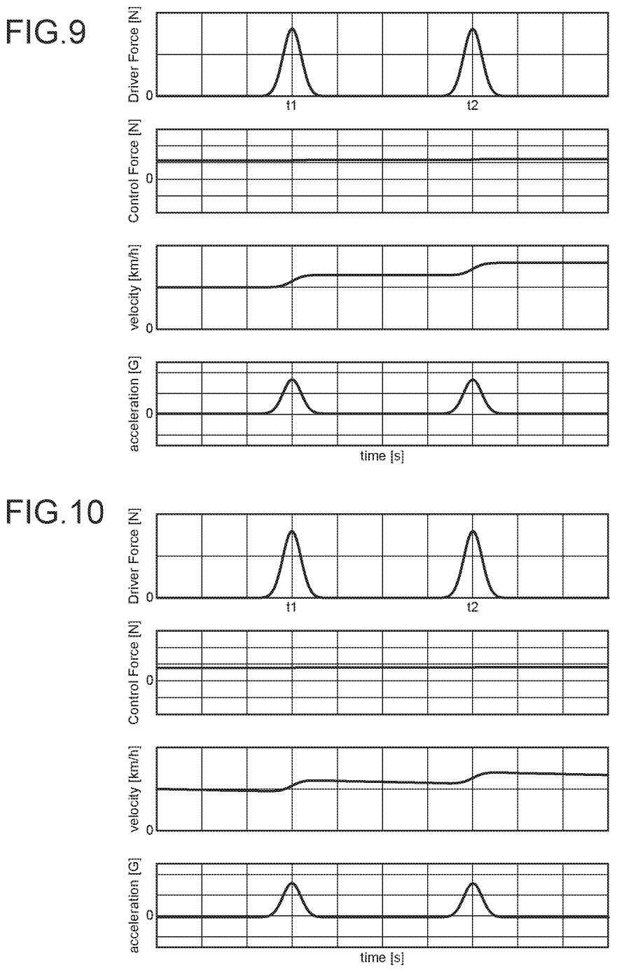

FIG. 9 to FIG. 11 are each a graph showing another example of the control processing of the kick skater 500. In FIG. 9 to FIG. 11, control of cancelling the traveling resistance by 100%, 70%, and 30% is executed. Note that In FIG. 9 to FIG. 11, the processing of amplifying the human force is not executed, and the second drive force command corresponding to the traveling resistance is used as a motor drive force command as it is.

In FIG. 9, the traveling resistance is cancelled by 100%, traveling on a virtual road surface 2 where the target traveling resistance is zero is possible. Thus, for example, in the case where no human force is applied, the kick skater 500 travels at a constant velocity, as shown in the graph of the velocity.

For example, when a human force is applied at the time t1, the velocity increases in accordance with the human force. Also during this time, the drive force similar to the traveling resistance is continuously supplied. For example, when the velocity is increased by the human force, the traveling resistance (air resistance and the like) increases. As shown in the graph of the drive force, the drive force gradually increases as the traveling resistance increases.

As described above, the controller 509 (the power calculation unit 60) is capable of constantly supplying the drive force corresponding to the traveling resistance regardless of the presence or absence of the human force. As a result, the human force is a force to be added to the drive force, and the human force and the drive force can be naturally coordinated. As a result, as shown in the graph of the acceleration, the kick skater 500 gradually accelerates and decelerates, and sudden changes in acceleration and the like can be sufficiently avoided.

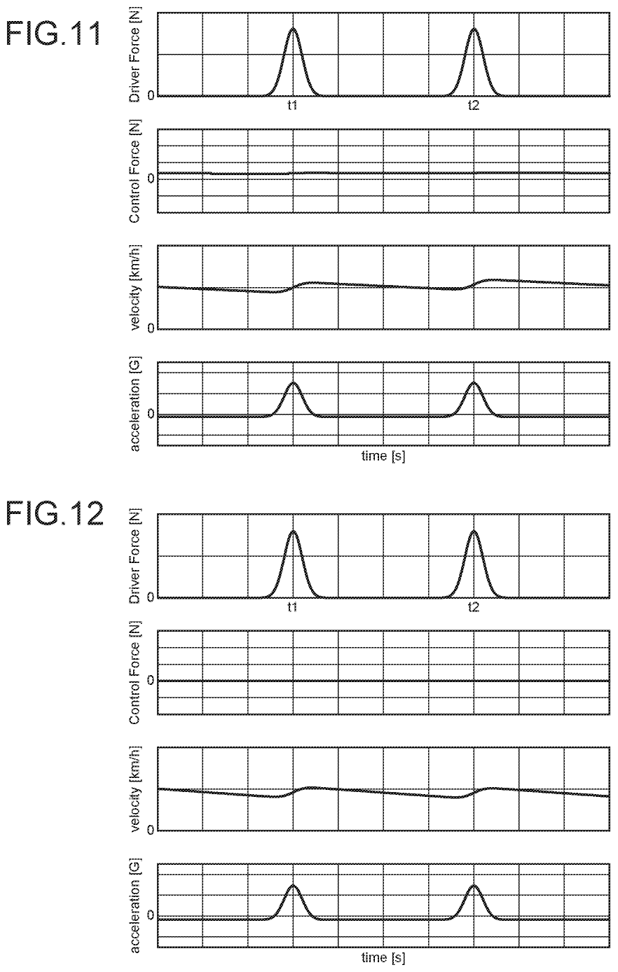

Further, even in the case where the human force is not amplified, it is possible to realize travelling assuming the road surface 2 with a virtual traveling resistance. For example, in the case where the traveling resistance is cancelled by 70% as shown in FIG. 10, the velocity is gradually reduced while no human force is applied. Further, in the state where the traveling resistance is cancelled by 30% as shown in FIG. 11, for example, the ratio of deceleration increases as compared with FIG. 10.

Note that as shown in FIG. 10 and FIG. 11, in any of the cases, since the drive force varies in accordance with the traveling resistance, a rapid change in the acceleration is not detected in the kick skater 500. Thus, it is possible to realize a natural driving experience with an arbitrary virtual resistance.

FIG. 12 is a graph showing an example of the traveling data of the kick skater 500. FIG. 12 is a graph showing the human force, drive force, velocity, and acceleration when the first and second drive force commands are both zero. As shown in the graph of the drive force, in FIG. 12, the drive force is zero and the force from the drive motor 506 is not supplied. That is, FIG. 12 is a graph when only the human force and the traveling resistance are acting.

In the acceleration shown in FIG. 9 to FIG. 11, since the drive force cancels the driving resistance, the base line (the acceleration when no human force is applied) is different from the acceleration shown in FIG. 12. Meanwhile, the graph of acceleration shown in FIG. 9 to FIG. 11 shows a peak structure substantially similar to the acceleration shown in FIG. 12 for the application of human forces at the times t1 and t2. Further, also the acceleration shown in FIG. 5 to FIG. 8 also shows a smooth peak structure similarly to the acceleration shown in FIG. 12. Note that in the peak structure of the acceleration of FIG. 5 to FIG. 8, the peak value is amplified with the amplification of the human force as compared with the acceleration shown in FIG. 12.

Thus, by performing the control process shown in FIG. 4, it is possible to realize a natural acceleration change similar to that when only the human force and the traveling resistance acts. That is, even when the drive force acts, the human force and the drive force can sufficiently cooperate with each other so as not to cancel with each other. As a result, the control in which the human force and the drive force are appropriately coordinated is realized, and excellent usability can be exhibited.

As described above, in the controller 509 according to this embodiment, the human force that moves the kick skater 500 and the traveling resistance imposed on the kick skater 500 are detected from external force information regarding the external force applied to the kick skater 500 having the drive motor 506. From this detected result, a first drive force command corresponding to the human force and a second drive force command corresponding to the traveling resistance are calculated, and the drive motor 506 of the kick skater 500 is controlled on the basis of the drive force commands. In this manner, by controlling the drive motor 506 in accordance with each of the human force and the resistance force, it is possible to improve usability of the kick skater 500 that is movable by a human force.

As a method of controlling a motor mounted on the vehicle that is movable by a human force, a method of generating a torque command value of a motor so as to follow the target velocity is conceivable. For example, when control of following the target velocity is performed, the force of a user kicking the ground as viewed from the control system acts as a disturbance that varies the vehicle velocity in some cases. For this reason, since the control system attempts to cancel the effect of the human force, there is a possibility that the torque of the motor and the human force cannot cooperate with each other.

Further, as a method of avoiding damping of the propulsion force by a human force, a method such as stopping the driving of a motor when the human force is applied is conceivable. In this method, there is a possibility that the propulsion force by the motor, which has withstood the traveling resistance, is suddenly reduced when a human force is applied and the deceleration feeling by the traveling resistance (sudden negative acceleration, etc.) occurs. Further, when human force application is completed and the control of a motor is resumed, there may be a case where the deceleration feeling due to the time lag of the feedback remains or a case where a sudden acceleration or the like for achieving the target velocity occurs. For this reason, there is a possibility that smooth traveling is hindered.

In this embodiment, a first drive force command corresponding to the human force (human force detection value) that causes the kick skater 500 to move is calculated. In addition, a second drive force command corresponding to the traveling resistance imposed on the kick skater 500 (traveling resistance detection value) is calculated. Then, using the first and second drive force commands, the drive force of the drive motor 506 is controlled.

In this way, the control of the drive motor 506 is processed with attention to the force applied to the kick skater 500. As a result, the drive motor 506 can be controlled without performing control of following a target value such as a target velocity. For this reason, for example, a situation in which a human force is canceled by the drive force of the drive motor 506 is avoided, and the human force and the drive force can be naturally coordinated.

Further, the drive motor 506 is controlled on the basis of the motor drive force command obtained by combining the first and second drive force commands corresponding to the human force and the traveling resistance. Thus, for example, in the case where a human force is applied, it is possible to realize control of damping the traveling resistance by amplifying the human force. Further, in the case where no human force is applied, the processing of appropriately damping the traveling resistance can be executed.

As described above, in this embodiment, the drive motor 506 is continuously controlled also when a human force is applied. In other words, regardless of the presence or absence of a human force, it is possible to generate a drive force corresponding to the traveling resistance, and cancel the traveling resistance. As a result, it is possible to sufficiently avoid a situation in which a sudden change in the acceleration of the kick skater 500 occurs due to a sudden change in the drive force, the effect of the traveling resistance, or the like. As a result, it is possible to provide a natural driving experience, and greatly improve the ride comfort of the kick skater 500.

The drive force of cancelling the traveling resistance, i.e. the second drive force command, is set on the basis of the virtual target traveling resistance. As a result, it is possible to realize a driving experience in which a human force is amplified while traveling on the road surface 2 (e.g., on ice) with a virtual traveling resistance. Thus, by performing the drive control using the target traveling resistance or the like, in the vehicle with propulsion by a human force, it is possible to provide a new driving experience.

Further, in this embodiment, the velocity of the kick skater 500 can be detected by using the image data obtained by imaging by the camera. For example, in the case where the velocity is detected using the rotational velocity of the wheel or motor, there is a possibility that the vehicle velocity cannot be properly detected due to the slippage of the tire. By using the image data, it is possible to calculate an actual moving amount or the like of the kick skater 500, and accurately detect the velocity of the kick skater 500. Further, even in the case where the wheel is slipped, it is possible to achieve proper velocity detection.

In addition, it is possible to detect the rolling resistance coefficient, the gradient, and the like of the road surface 2 on the basis of the image data. In this manner, by using the image data, it is possible to easily acquire various pieces of information regarding the traveling environment of the kick skater 500. As a result, it is possible to realize detailed control according to the traveling environment, and sufficiently improve usability of the kick skater 500.

### Other Embodiments

The present technology is not limited to the embodiments described above, and can achieve various other embodiments.

In the embodiments described above, the human force detection value has been calculated on the basis of the output from the human force sensor provided in the drive pedal. The present technology is not limited thereto. For example, the present technology is applicable also to a configuration in which no human force sensor is provided.

In the case where the human force sensor is not provided, for example, the processing by the human force calculation unit shown in FIG. 2, i.e., Step108 shown in FIG. 4 and the like can be omitted. In this case, the power calculation unit is capable of calculating the estimation-based human force detection value from the external force detection value and the measurement-based traveling resistance detection value (solid arrow shown in FIG. 3). In the case where there is no human force sensor, the processing represented by the dotted arrows shown in FIG. 3 is not executed.

Even in the case where a drive pedal (drive mechanism) or the like is not provided, it is possible to detect the propulsion force (human force) generated by a user kicking a road surface, by detecting an external force. Thus, even in the case where the human force of the user cannot be directly detected (measured), it is possible to detect the human force by detecting the external force applied to the kick skater, and naturally control the drive motor.

In the above, the electric kick skater using a drive motor or the like has been described. The power of the kick skater is not limited to a motor or the like. For example, as the power, an internal combustion engine such as an engine may be used. In this case, a fuel tank or the like may be installed instead of a battery. Even in the case where an engine or the like is used, it is possible to realize a natural driving experience by controlling the engine output using the present technology.

In the above, a kick skater has been described as an example of the moving object that is movable by a human force. The present technology is not limited thereto, and the description of the present disclosure can be applied to various products. For example, the technology according to the present disclosure may be implemented as a device mounted on any type of moving object such as a powered skating board, a bicycle, a paddle boat, a cart, and a trolley.

In the above-mentioned embodiment, the control method according to the present technology including the control of the drive motor and the like has been executed by the controller mounted on the kick skater. The present technology is not limited thereto, and the control method according to the present technology may be executed by a cloud server. In this case, the cloud server acts as a control device according to the present technology.

In addition, a computer mounted on a kick skater may be linked to another computer (cloud server) capable of communicating with the computer via a network or the like to execute the control method and the program according to the present technology, thereby constructing the control device according to the present technology.

That is, the control method and the program according to the present technology can be executed not only in a computer system including a single computer but also in a computer system in which a plurality of computers operate in conjunction with each other. Note that, in the present disclosure, the system means an aggregate of a plurality of components (such as apparatuses and modules (parts)) and it does not matter whether or not all the components are housed in the identical casing. Thus, a plurality of apparatuses accommodated in separate casings and connected to one another through a network, and a single apparatus in which a plurality of modules is accommodated in a single casing are both the system.

The execution of the control method and the program according to the present technology by a computer system includes, for example, both a case where acquiring external force information regarding an external force to be applied to a kick skater, detecting a human force and a traveling resistance, controlling a drive motor, and the like are executed by a single computer, and a case where each of the processes is executed by different computers. Further, the execution of the respective processes by a predetermined computer includes causing another computer to execute some or all of those processes and acquiring results thereof.

That is, the control method and the program according to the present technology can be applied to the configuration of the cloud computing in which one function is shared among a plurality of devices through a network and processed in conjunction with each other.

Out of the feature parts according to the present technology described above, at least two feature parts can be combined. In other words, various features described in the respective embodiments may be combined discretionarily regardless of the embodiments. Further, the various effects described above are not limitative but are merely illustrative, and other effects may be provided.

Note that the present technology may also take the following configurations.

(1) A control device, including:

an acquisition unit that acquires external force information regarding an external force to be applied to a moving object including a drive source;

a detection unit that detects a human force and a resistance force on a basis of the acquired external force information, the human force causing the moving object to move, the resistance force being imposed on the moving object; and

a control unit that calculates a first control value corresponding to the detected human force, and a second control value corresponding to the detected resistance force, and controls the drive source on a basis of the first and second control values.

(2) The control device according to (1), in which

the control unit combines the first control value and the second control value to calculate a combined control value, and controls the drive source on a basis of to the calculated combined control value.

(3) The control device according to (1) or (2), in which

the second control value is a control value for canceling a resistance force to be imposed on the moving object.

(4) The control device according to any one of (1) to (3), in which

the control unit calculates a second control value for realizing a virtual moving resistance by reducing the detected resistance force.

(5) The control device according to any one of (1) to (4), in which

the first control value is a control value for amplifying a human force that moves the moving object.

(6) The control device according to any one of (1) to (5), in which

the control unit removes a deceleration component that decelerates the moving object from the detected human force, and calculates the first control value from the human force from which the deceleration component has been removed.

(7) The control device according to any one of (1) to (6), in which

the detection unit is capable of detecting, on a basis of the external force information, the external force applied to the moving object.

(8) The control device according to (7), in which

the detection unit detects the human force by subtracting the resistance force from the detected external force.

(9) The control device according to (7) or (8), in which

the external force information includes an output from a human force sensor mounted on the moving object, and

the detection unit detects the human force on a basis of the output of the human force sensor, and detects the resistance force by subtracting the human force from the detected external force.

(10) The control device according to any one of (1) to (9), in which

the moving object is a kick vehicle, and

the detection unit detects, as the human force, a force that kicks a road surface on which the vehicle travels.

(11) The control device according to any one of (1) to (10), in which

the moving object includes a drive mechanism that converts the human force into a propulsion force of the moving object, and

the detection unit detects the propulsion force as the human force.

(12) The control device according to any one of (1) to (11), in which

the moving object includes a wheel that is in contact with a road surface, and

the detection unit detects, as the resistance force, at least one of a rolling resistance of the wheel, a gradient resistance of the road surface, and an air resistance.

(13) The control device according to any one of (1) to (12), in which

the moving object includes a sensor unit including at least one of an acceleration sensor, a velocity sensor, an image sensor, and a wind velocity sensor, and

the acquisition unit acquires an output of the sensor unit as the external force information.

(14) The control device according to (13), in which

the detection unit detects a velocity of the moving object on a basis of the output of the image sensor.

(15) The control device according to (13) or (14), in which

the moving object includes a wheel that is in contact with a road surface, and

the detection unit detects a rolling resistance coefficient of the wheel with respect to the road surface on a basis of the output of the image sensor.

(16) The control device according to any one of (13) to (15), in which

the detection unit detects a gradient of a road surface on a basis of an output of the image sensor.

(17) A control method executed by a computer system, including:

acquiring external force information regarding an external force to be applied to a moving object including a drive source;

detecting a human force and a resistance force on a basis of the acquired external force information, the human force causing the moving object to move, the resistance force being imposed on the moving object; and

calculating a first control value corresponding to the detected human force, and a second control value corresponding to the detected resistance force, and controlling the drive source on a basis of the first and second control values.

(18) A program that causes a computer system to execute the following steps of:

acquiring external force information regarding an external force to be applied to a moving object including a drive source;

detecting a human force and a resistance force on the basis of the acquired external force information, the human force causing the moving object to move, the resistance force being imposed on the moving object; and

calculating a first control value corresponding to the detected human force, and a second control value corresponding to the detected resistance force, and controlling the drive source on the basis of the first and second control values.

(19) A moving object, including:

a drive source that causes the moving object to move;

an acquisition unit that acquires external force information regarding an external force to be applied to a moving object including a drive source;

a detection unit that detects a human force and a resistance force on the basis of the acquired external force information, the human force causing the moving object to move, the resistance force being imposed on the moving object; and

a control unit that calculates a first control value corresponding to the detected human force, and a second control value corresponding to the detected resistance force, and controls the drive source on the basis of the first and second control values.

### REFERENCE SIGNS LIST

1 user
2 road surface
10 data acquisition unit
20 parameter calculation unit
30 external force calculation unit
40 human force calculation unit
50 traveling resistance calculation unit
60 power calculation unit
61 external force processing unit
62 human force processing unit
63 traveling resistance processing unit
64 combining processing unit
500 kick skater
503 front wheel
504 rear wheel
505 drive pedal
506 drive motor
509 controller
516 drive mechanism
520 wheel velocity sensor
521 acceleration sensor
522 camera
523 wind velocity sensor
524 human force sensor

1. A control device, comprising:
an acquisition unit that acquires external force information regarding an external force to be applied to a moving object including a drive source;
a detection unit that detects a human force and a resistance force on a basis of the acquired external force information, the human force causing the moving object to move, the resistance force being imposed on the moving object; and
a control unit that calculates a first control value corresponding to the detected human force, and a second control value corresponding to the detected resistance force, and controls the drive source on a basis of the first and second control values.

2. The control device according to claim 1, wherein
the control unit combines the first control value and the second control value to calculate a combined control value, and controls the drive source on a basis of to the calculated combined control value.

3. The control device according to claim 1, wherein
the second control value is a control value for canceling a resistance force to be imposed on the moving object.

4. The control device according to claim 1, wherein
the control unit calculates a second control value for realizing a virtual moving resistance by reducing the detected resistance force.

5. The control device according to claim 1, wherein
the first control value is a control value for amplifying a human force that moves the moving object.

6. The control device according to claim 1, wherein
the control unit removes a deceleration component that decelerates the moving object from the detected human force, and calculates the first control value from the human force from which the deceleration component has been removed.

7. The control device according to claim 1, wherein
the detection unit is capable of detecting, on a basis of the external force information, the external force applied to the moving object.

8. The control device according to claim 7, wherein
the detection unit detects the human force by subtracting the resistance force from the detected external force.

9. The control device according to claim 7, wherein
the external force information includes an output from a human force sensor mounted on the moving object, and
the detection unit detects the human force on a basis of the output of the human force sensor, and detects the resistance force by subtracting the human force from the detected external force.

10. The control device according to claim 1, wherein
the moving object is a kick vehicle, and
the detection unit detects, as the human force, a force that kicks a road surface on which the vehicle travels.

11. The control device according to claim 1, wherein
the moving object includes a drive mechanism that converts the human force into a propulsion force of the moving object, and
the detection unit detects the propulsion force as the human force.

12. The control device according to claim 1, wherein
the moving object includes a wheel that is in contact with a road surface, and
the detection unit detects, as the resistance force, at least one of a rolling resistance of the wheel, a gradient resistance of the road surface, and an air resistance.

13. The control device according to claim 1, wherein
the moving object includes a sensor unit including at least one of an acceleration sensor, a velocity sensor, an image sensor, and a wind velocity sensor, and
the acquisition unit acquires an output of the sensor unit as the external force information.

14. The control device according to claim 13, wherein
the detection unit detects a velocity of the moving object on a basis of the output of the image sensor.

15. The control device according to claim 13, wherein
the moving object includes a wheel that is in contact with a road surface, and
the detection unit detects a rolling resistance coefficient of the wheel with respect to the road surface on a basis of the output of the image sensor.

16. The control device according to claim 13, wherein
the detection unit detects a gradient of a road surface on a basis of an output of the image sensor.

17. A control method executed by a computer system, comprising:
acquiring external force information regarding an external force to be applied to a moving object including a drive source;
detecting a human force and a resistance force on a basis of the acquired external force information, the human force causing the moving object to move, the resistance force being imposed on the moving object; and
calculating a first control value corresponding to the detected human force, and a second control value corresponding to the detected resistance force, and controlling the drive source on a basis of the first and second control values.

18. A program that causes a computer system to execute the following steps of:
acquiring external force information regarding an external force to be applied to a moving object including a drive source;
detecting a human force and a resistance force on the basis of the acquired external force information, the human force causing the moving object to move, the resistance force being imposed on the moving object; and
calculating a first control value corresponding to the detected human force, and a second control value corresponding to the detected resistance force, and controlling the drive source on the basis of the first and second control values.

19. A moving object, comprising:
a drive source that causes the moving object to move;
an acquisition unit that acquires external force information regarding an external force to be applied to a moving object including a drive source;
a detection unit that detects a human force and a resistance force on the basis of the acquired external force information, the human force causing the moving object to move, the resistance force being imposed on the moving object; and
a control unit that calculates a first control value corresponding to the detected human force, and a second control value corresponding to the detected resistance force, and controls the drive source on the basis of the first and second control values.
